(19) United States
(12) Patent Application Publication
(10) Pub. No.: US 2026/0067715 A1
(43) Pub. Date: Mar. 5, 2026

(54) NETWORK CHURN GENERATOR

(71) Applicant: T-MOBILE INNOVATIONS LLC, Overland Park, KS (US)

(72) Inventor: Chaitanya CHUKKA, Carol Stream, IL (US)

(21) Appl. No.: 18/818,318

(22) Filed: Aug. 28, 2024

(51) Int. Cl. H04W 24/02; H04L 41/16; H04W 24/08

(52) U.S. Cl. CPC H04W 24/02; H04L 41/16; H04W 24/08

(57) ABSTRACT

At a high level, the technology disclosed herein relates to methods, systems, media, etc., for generating enhanced churn predictions and implementing particular actions based on the enhanced churn predictions. In embodiments, a serving location and cell site can be leveraged from the radio head in real-time to understand specific user device perspectives of the network. For example, computing resources and adaptive machine learning models implemented within the radio head can leverage network outage data, geographical information, historical churn rates, current network experiences, share of household data, demographics, etc., for particular areas for enhanced churn predictions. In embodiments, feedback can be aggregated with the other network data and network experience data to implement adaptive machine learning models for generating the enhanced churn predictions.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for generating churn predictions and implementing solutions based on the enhanced churn predictions. For example, the technology disclosed herein relates to generating the enhanced churn predictions based on providing network data and network experience data to a trained adaptive machine learning model. To illustrate, the trained adaptive machine learning model may be generated using radio head resources and cell site node(s) (e.g., eNodeB). The network data and network experience data may be specific to particular location and demographic information associated with particular user devices and particular groupings of user devices. Stated differently, in embodiments, a serving location and cell site can be leveraged from the radio head in real-time to understand specific user device perspectives of the network to generate the trained adaptive machine learning model and the enhanced churn predictions. In embodiments, the adaptive machine learning model(s) may be implemented within the radio head of the cell site node(s).

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for utilizing a network churn generator, in accordance with embodiments herein;

FIG. 2 depicts an example flowchart for generating enhanced churn predictions, in accordance with embodiments herein; and

FIG. 3 depicts an example network churn generator client and corresponding functionality associated with the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, churn can generally refer to measurements of retention by telecommunication service subscribers. For example, churn may be measured in terms of the number of subscribers who cancel subscriptions or who do not renew subscriptions, or revenue lost due to these subscriber changes. Churn may apply to many industries, such as the telecommunications industry, software-as-a-service (SaaS) industry, video streaming industry, gaming industry, financial service industry, fitness or health industries, travel industry, etc.

Understanding churn and its complex characteristics (e.g., root cause analysis) can be challenging. For example, churn can be a multifaceted analysis including subscriber behavioral factors (e.g., personal preferences, usage patterns, satisfaction levels), the landscape and availability of alternatives (e.g., competitor services and pricing), service features and quality offered, data volume and complexities associated with data collection and processing of data related to churn, data feature selection, modeling subscriber behavior, the dynamic nature of churn (e.g., market conditions and subscriber behavior changes over time), the capability to identify specific reasons for particular subscribers churning, and so forth. As another example, churn analysis may occur at later stages that do not occur during real-time (e.g., a subscriber deciding to churn for reasons that transpired before the instance of churning), and as such, the monitoring of churn performed and models are designed at a later stage relative to the reasons for churning.

It would be desirable for enhanced churn predictions to implement particular computational operations to retain or improve subscriber experiences (e.g., user device experiences and network performance optimization). As such, embodiments of the technology discussed herein provide various improvements to churn prediction, churn data feature selection, model design and implementation, enhancements to cell site node operations and improved usages of computing resources, enhanced ways to improve network performance based on the enhanced churn predictions, improvements to user device experiences based on the enhanced churn predictions, reduce network congestion based on the enhanced churn predictions, reduce latencies and packet transmission delays based on the enhanced churn predictions, etc. By way of example, by providing particular network data and particular network experience data to a trained adaptive machine learning model, a network churn generator can provide enhanced churn predictions that result in the improvements to cell site node operations, improved usages of computing resources, as well as the other improvements mentioned above.

In an embodiment, a system is provided. The system may comprise one or more processors and computer memory storing computer-usable instructions that, when executed by the one or more processors, cause the one or more processors to perform operations. For example, the operations may comprise determining cell sites in which a user device communicates with over a threshold. The operations may also comprise retrieving network data and network experience data for the cell sites that correspond to the user device. The operations may also comprise providing the network data and the network experience data to a trained adaptive machine learning model. Based on providing the network data and the network experience data to the trained adaptive machine learning model, the operations may further comprise determining that the user device has a particular churn probability, and providing an indication of the user device having the particular churn probability.

In another embodiment, a method for network churn prediction is provided. The method may comprise identifying a cell site in which a user device communicates with over a threshold, and retrieving network data and network experience data for the cell site that corresponds to the user device. The method may also comprise providing the network data and the network experience data to a set of trained adaptive machine learning models. Based on providing the network data and the network experience data to the set of trained adaptive machine learning models, the method may also comprise determining that the user device has a probability to churn. The method may also comprise providing an indication of the user device having the probability to churn.

In another example embodiment, one or more computer storage media having computer-executable instructions embodied thereon, that when executed by at least one processor, cause the at least one processor to perform a method. The method may comprise identifying historical locations a user device frequented above a threshold. The method may also comprise retrieving network data and network experience data for the user device based on the historical locations. The method may also comprise providing the network data and the network experience data to a trained adaptive machine learning model. Based on providing the network data and the network experience data to the trained adaptive machine learning model, the method may also comprise determining that the user device has a probability to churn, and causing the transmission of an indication of the user device having the probability to churn.

### Example Operating Environment

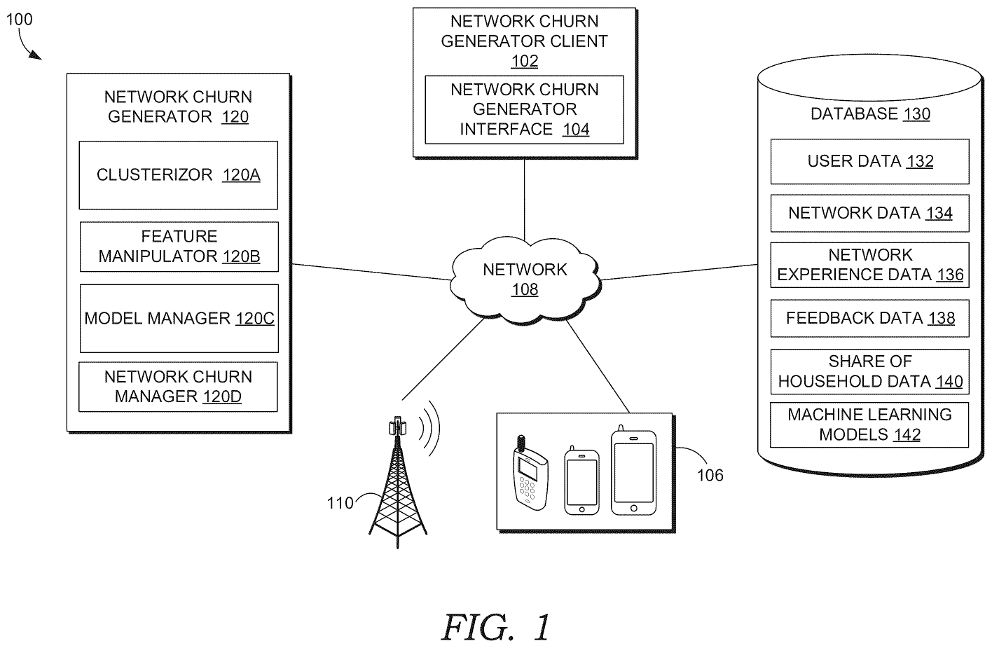

Turning now to FIG. 1, example operating environment 100 is illustrated in accordance with one or more embodiments disclosed herein. At a high level, the example operating environment 100 comprises network churn generator client 102 including network churn generator interface 104; user devices 106; network 108; base station 110; network churn generator 120 including clusterizor 120A, feature manipulator 120B, model manager 120C, and network churn manager 120D; and database 130 including user data 132, network data 134, network experience data 136, feedback data 138, share of household data 140, and machine learning model(s) 142.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional network churn generator clients or other configurations of the database 130 (e.g., database 130 may be a distributed computing environment encompassing multiple computing devices for storing one or more of the user data 132, network data 134, network experience data 136, feedback data 138, share of household data 140, and machine learning model(s) 142).

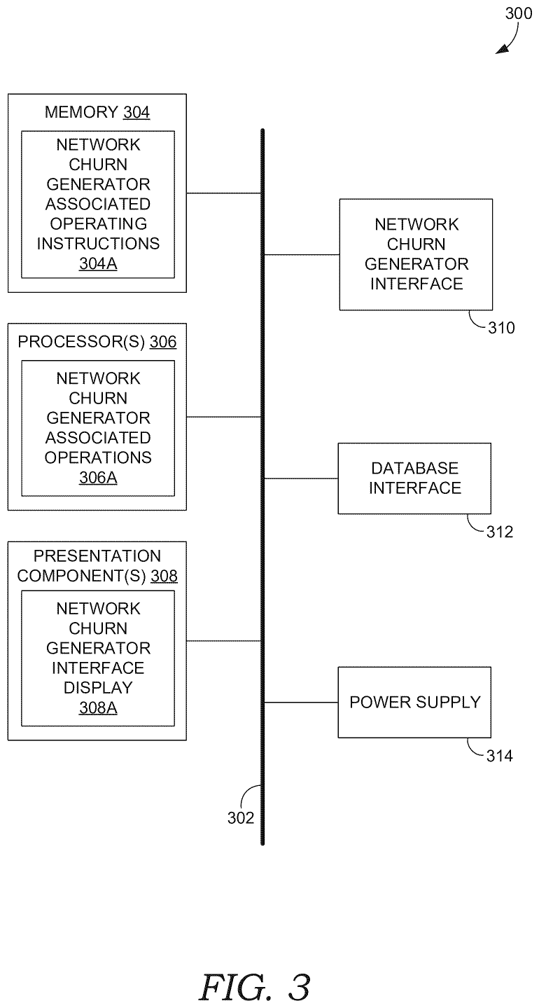

Network churn generator client 102 may be a device that has the capability of communicating (e.g., transmitting or receiving one or more signals to or from) with one or more of the user devices 106, base station 110, network churn generator 120, and database 130 over the network 108. In some embodiments, the network churn generator client 102 or one or more of the user devices 106 may be a “user device,” “computing device,” “mobile device,” “client,” “user equipment (UE),” or “wireless communication device.” In some embodiments, the network churn generator client 102 may be a server. The network churn generator client 102 or one or more of the user devices 106, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating over the network 108. In some embodiments, the network churn generator client 102 may be example network churn generator client 300 described herein with respect to FIG. 3.

The network churn generator client 102 may be, in an embodiment, capable of providing for display, via the network churn generator interface 104 (e.g., via presentation component(s) 308 of FIG. 3), one or more data items stored within database 130 (e.g., the user data 132, network data 134, network experience data 136, feedback data 138, share of household data 140, and machine learning model(s) 142), churn determinations, other types of network churn generator output, etc., or one or more combinations thereof. In embodiments, the network churn generator interface 104 may be one or more presentation component(s) 308 of FIG. 3. In embodiments, the network churn generator interface 104 may display image data, text data, extended reality data, other types of data, or one or more combinations thereof, based on one or more operations of the network churn generator 120 (e.g., operations associated with the clusterizor 120A, feature manipulator 120B, model manager 120C, and network churn manager 120D, etc.).

In embodiments, the network 108 may include one or more of a local area network (LAN), a wide area network (WAN), a mesh network, a hybrid network, a plurality of networks, another type of network, or one or more combinations thereof. In some embodiments, one or more components (e.g., network churn generator client 102, user devices 106, base station 110, network churn generator 120, etc.) illustrated within the example operating environment 100 may communicate over the network 108 via the Internet, another public or private network, etc., or one or more combinations thereof. In some embodiments, the network 108 includes 5G standalone technology (independent of 4G technology), 5G non-standalone technology, LTE network technology, another generation network technology, 802.11x, etc., or one or more combinations thereof.

In embodiments, the base station 110 may be a macro cell or another type of cell site (e.g., a micro cell, a picocell, femtocell, small cell, microcell, a distributed antenna system (e.g., a network of distributed antennas connected to a central source), a remote radio head, etc.). In embodiments, the base station 110 may be a station that communicates with the user devices 106, the network churn generator 120, the network churn generator client 102, etc., and may, in some implementations, be an evolved node B (eNB), a next generation eNB (gNB), an access point, etc., or one or more combinations thereof. The base station 110 may provide communication coverage for a particular geographical coverage area. In some embodiments, the base station 110 may be associated with a same operator or different operators, such as the example operating environment 100 may include one or more operator wireless networks. For example, a “subscriber” may refer to a user device that subscribes to services (e.g., telecommunication services) provided by a particular operator. In embodiments, the base station 110 may provide communication services via one or more frequency bands in licensed spectrum, unlicensed spectrum, etc., or one or more combinations thereof.

In embodiments, data stored within the database 130 may be stored, received, accessed, retrieved, or otherwise managed based on one or more particular communications (e.g., transmitting) or operations by one or more of the base station 110, the network churn generator 120, and the network churn generator client 102.

In embodiments, user data 132 may correspond to user data associated with a particular user device of the user devices 106. For example, the user data 132 may include a mobile directory number (MDN) or a mobile identification number (MIN), historical location data for a user device, credit scores or credit reporting data, geographical information associated with the user device (e.g., a home address, a work address, an address associated rural indicator, an address associated urban indicator, etc.), age, gender, income data, subscription data (e.g., subscription plan type, subscription bundle(s), subscription promotions, subscription discounts, tenure of subscription, etc.), historical calls or interactions with the subscription provider (e.g., calls to care, calls related to network issues, call associated with billing or other services, other types of notifications to the subscription provider, a number of in-person visits with the subscription provider, etc.), social media data, etc., or one or more combinations thereof.

In embodiments, the network data 134 may include live network data (e.g., a live network status, network outages, network availability, availability of tiered or different subscriptions related to network services, etc.), cell site modification data, cell broadcast group echolocate data (e.g., echo-based data; emergency alert data, location-based services data, information dissemination data, etc., associated with a group of cells targeted for simultaneous message broadcasting), network speed testing data, network latency data, network leakage data (e.g., unauthorized transmissions of data, unintended data transmission path, signal leakage), quality of service data, quality of experience data, network overloading data (e.g., 5G congestion), degraded service quality data, internet data transfer speed, impaired internet user experience data, number of user device requests per second for a particular network component, other types of network data, etc.

In embodiments, the network experience data 136 may include user device voice usage, billing account number, payload usage, voice dropped call count, voice dropped call rate, voice muting, voice garbling, voice soft drops, LTE low coverage, LTE data leakage, average LTE throughput, 5G data leakage, 5G throughput, 5G latency, 5G low coverage, time between radio access technology change, an average air interface, e.g., Long-Term Evolution (LTE) or 5G, throughput value, voice muting, voice garbling, voice soft drops, or number of minutes between radio access technology (RAT) change, access failure rate, customer lifetime value, Received Signal Strength Indicator (RSSI), Reference Signal Received Power (RSRP), Reference Signal Received Quality (RSRQ), Signal to Interference plus Noise Ratio (SINR), Channel Quality Indicator (CQI), timing advance, frequency band usage, service provider comparison values, an average air interface, lack of coverage, how often a user device has a signal below a threshold, percentage of low coverage, home coverage signal strength, latency, leakage, an amount of time spent on lower technologies (e.g., 4G instead of 5G), etc., or one or more combinations thereof.

In embodiments, the network experience data 136 may include historical churn data. For example, historical churn data may include a historical quarter churn percentage or value for a particular household or a particular grouping of households (e.g., within a particular zip code), or a month-by-month churn rate for a particular set of user device within a particular area. In some embodiments, the historical churn data may include a churn value per zip code, a churn value per city, a churn value per state, a churn trend for a particular time period, churn comparisons for different service providers during a particular time period, a total for deactivations or accounts that were closed or deactivated during a previous quarter (e.g., voluntary deactivations, involuntary deactivations), the number of service transfers to another provider during a previous quarter, a percentage of subscribers who port into their provider's service from another provider, a percentage of subscribers who port out from their provider's service to another provider, etc., or one or more combinations thereof.

In embodiments, the feedback data 138 may include electronic survey feedback from subscribers, issues reported by subscribers, subscriber escalations (e.g., subscribers classified for higher support or management levels for resolution), calls to care (e.g., subscriber calls for service support, a volume of calls to care for a time period, average handling time, first call resolution rate, subscriber satisfaction scores), reported issue descriptions, reported issue types (e.g., network outage, poor signal quality, low internet speed), service charges, issue fees, increases or reductions to fees, subscription categories, in-store experiences, in-store visits, in-store purchases, in-store upgrades, in-store survey responses, etc., or one or more combinations thereof.

In embodiments, the share of household data 140 may include household zip code data for user devices, household area code data, household subscriptions and bundles, census data associated with each household, simplified maximum revenue allocation associated with each household or a grouping of households, hexagonal binning cell broadcast group data associated with each household, a percentage of households using a particular broadband or fiber service, a percentage of households subscribed to a cable service, satellite service, or streaming service, etc., or one or more combinations thereof. In some embodiments, the share of household data 140 may include a combination of all the households in a particular city or area, and a value corresponding to a particular number of subscribers for one provider versus the number of subscribers for another provider within that particular area for the total households for that area.

In embodiments, each of the user data 132, network data 134, network experience data 136, feedback data 138, and the share of household data 140 may be labeled or organized based on a particular user device identifier and a particular network component identifier. Additionally or alternatively, in some embodiments, the user data 132, network data 134, network experience data 136, and feedback data 138 may be labeled or organized based on historical location data for each particular user device. Additionally or alternatively, in some embodiments, the user data 132, network data 134, network experience data 136, and feedback data 138 may be labeled or organized based on the share of household data 140 for each particular user device.

In embodiments, the machine learning models 142 may include one or more supervised machine learning models and one or more unsupervised machine learning models. In embodiments, the machine learning models 142 may include one or more of a linear regression model, a Bayes algorithm, a support vector machine algorithm, a random forest algorithm, a decision tree, a logistic regression model, a gradient boosting model, a K-Nearest Neighbor algorithm, a K-means clustering, dimensionally reduction algorithm, etc. For example, one or more of the machine learning models 142 may be used to generate the trained adaptive machine learning model. In embodiments, the clusterizor 120A, the feature manipulator 120B, and the model manager 120C can be used to generate the trained adaptive machine learning model.

In embodiments, the network churn generator 120 may comprise computing devices (e.g., one or more servers). In some embodiments, the network churn generator 120 may be a single server, a distributed computing environment encompassing multiple computing devices located at the same physical geographical location or at different physical geographical locations, another type of server environment, etc. In embodiments, the network churn generator 120 may comprise one or more processors, one or more electronics devices, one or more hardware devices, one or more electronics components, one or more logical circuits, one or more memories, one or more software codes, one or more firmware codes, etc., or one or more combinations thereof.

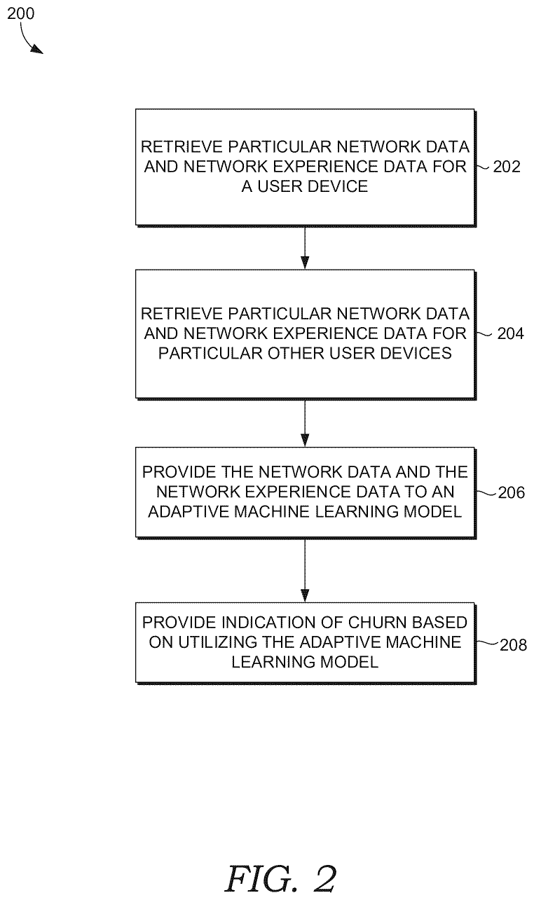

The network churn generator 120 may access the database 130 to execute tasks (e.g., associated with the clusterizor 120A, feature manipulator 120B, model manager 120C, and network churn manager 120D, etc.). For example, a user—via the network churn generator client 102 (e.g., via the network churn generator interface 104)—may transmit a request to communicate with the network churn generator 120. The network churn generator 120 may receive, retrieve, analyze, store, generate, etc., the user data 132, network data 134, network experience data 136, feedback data 138, share of household data 140, and machine learning model(s) 142 at/from the database 130. In embodiments, the network churn generator 120 may perform one or more of the steps 202-208 of FIG. 2.

In some embodiments, the network churn generator 120 may determine cell site(s) (e.g., based on user data 132, network data 134, network experience data 136, etc.) in which each of the user devices 106 communicate with over a threshold (e.g., a threshold number of radio resource control (RRC) connection requests or RRC connection establishments, a threshold based on historical location data for a user device). Based on the determined cell site(s), the network churn generator 120 may retrieve particular data from the database 130 that corresponds to each individual user device and the associated cell site(s). For example, the network churn generator 120 may retrieve age, gender, income data, and subscription data for the user device, a live network status for the determined cell site(s), historical network outages for a particular time period for the determined cell site(s), a current network availability for the determined cell site(s), cell broadcast group echolocate data associated with the user device and the determined cell site(s), a historical quarter churn value for households associated with a zip code corresponding to a home address of the user device, electronic survey feedback from the user device, network issues reported by the user device, subscriber escalations for the user device, etc.

The network churn generator 120 may also identify historical locations a user device frequented above a threshold (e.g., above a threshold period of time for a certain number of days). In embodiments, the network churn generator 120 retrieve particular data from the database 130 (e.g., network data 134 and network experience data 136) for the user device based on the historical locations. For example, based on the historical locations identified as being frequented above the threshold, particular network data 134 and network experience data 136 may be retrieved for that user device that are associated with particular network components corresponding to those historical locations (e.g., RSSI and RSRP generated by the user device for signals received from those network components).

In embodiments, network churn generator 120 may also identify other user devices that communicate with the determined cell sites over the threshold, and retrieve data from the database 130 for the other user devices that correspond to the determined cell sites (e.g., retrieve feedback data 138 from the other user devices, the feedback data associated with the network data and the network experience data for the cell sites). In some embodiments, the other user devices may be identified based on one or more of the user data 132, network data 134, network experience data 136, feedback data 138, and share of household data 140. As an example, the other user devices may be identified based on the other devices communicating with the cell site over the threshold, and based on having historical location data within a threshold distance from the user device.

The clusterizor 120A may perform data wrangling on the identified particular user data 132, network data 134, network experience data 136, feedback data 138, and share of household data 140, such as cleaning the data, removing abnormalities and deviants and filtering, converting feedback text into a standardized format, converting voice inputs from surveys into actionable items, etc. By way of example, the clusterizor 120A may segregate and bin the identified particular user data 132, network data 134, network experience data 136, feedback data 138, and share of household data 140. To illustrate, the identified particular data may be categorized into actionable items and particular categorized actionable items may be prioritized.

For instance, with respect to prioritization, the clusterizor 120A may apply an increased weighted value to negative feedback from the feedback data 138, or for user devices having reported negative feedback above a threshold number of times. As another example, the clusterizor 120A may apply an increased weighted value to higher dropped call rates, higher access failure rates, and higher historical network outages experienced. In yet another example, user data 132, network data 134, network experience data 136, feedback data 138, and share of household data 140 indicating a pattern of weak network coverage for a user device or user device grouping may be assigned an increased ranking identifier.

With respect to the binning, the clusterizor 120A may bin the data for the user devices from the database 130 based on user devices that are located within a particular city having a population density over a threshold, as well as binning user devices located within a particular suburb of that city. By way of illustration, for the user devices located within the particular suburb, a plurality of cell sites that communicate with those user devices may be identified, and the data from the database 130 may be binned based on the data within the database 130 for those user devices corresponding to those cell sites. Additionally, other user devices that communicate with those cell sites (e.g., that are not within that suburb) may be identified for binning as well. In some embodiments, data within the database 130 may be binned based on the data having particular neighbor relationship metrics associated with user devices (e.g., user devices having overlapping historical location data).

In some embodiments, the clusterizor 120A may prioritize the data for the user devices from the database 130 based on stationary (rather than transitory) location data. For example, the clusterizor 120A may tag particular data within the database 130 that corresponds to stationary locations for the user device (e.g., based on the user device being at a particular location for a threshold period of time). In some embodiments, the clusterizor 120A may prioritize the data for the user devices from the database 130 based on the user device being associated with a particular entity (e.g., a particular company or military branch based on the user data 132 or share of household data 140).

Based on the operations of the clusterizor 120A, the feature manipulator 120B may perform classification operations (e.g., decision tree classification, logistic regression, support vector machines, k-nearest neighbor, neural network) on the binned data. For instance, the feature manipulator 120B may timeline previous churn events and classify each of the previous churn events. As another example, the feature manipulator 120B may classify particular network data 134 and particular network experience data 136 associated with the previous churn events. For instance, the feature manipulator 120B may classify low coverage network data, high call drops at a subscriber location, high call drops at a cell site within a specific coverage area, etc. The feature manipulator 120B may also transform raw data (e.g., feedback data 138 classified as being associated with a previous churn event) into specific features for training the adaptive machine learning models via the model manager 120C.

The feature manipulator 120B may also extract particular features by mapping network experience data 136 (e.g., including coverage scores for particular areas or user devices), live network statuses of cell sites serving user devices, and previous calls to care, to a particular user identifier. For example, the mapping to the user identifier can be used to generate a correlation matrix and to generate variables for training the adaptive machine learning models via the model manager 120C. Additionally, the feature manipulator 120B may extract the increased ranking identifiers (e.g., increased ranking identifiers for tenured subscriptions over a threshold period of time, increased ranking identifiers for bundled user device subscriptions, increased ranking identifiers for combined previous churn events associated with a particular zip code) for training the adaptive machine learning models via the model manager 120C.

The model manager 120C may generate the adaptive machine learning model based on the operations of the v. For example, the model manager 120C may apply weights to particular extracted features and may benchmark the user identifiers with specific matrixes to implement the adaptive machine learning model (from the machine learning models 142) for determining whether a user device has a probability to churn. For example, the model manager 120C may factor a marketing budget compared to a revenue stream for a specific coverage area associated with a zip code to measure a logistic model of the machine learning models 142 for its determinations for a user device having a probability to churn. As another example, the model manager 120C may implement a combinations of the machine learning models 142, such that the adaptive machine learning model includes both supervised and unsupervised models. In some embodiments, the model manager 120C may train the adaptive machine learning model based on the training embodiments described for flowchart 200 of FIG. 2.

The network churn manager 120D may provide an indication of the user device having the probability to churn. The network churn manager 120D may also provide additional indications (e.g., a second indication) of other user devices having the particular churn probability or another churn probability. The network churn manager 120D may provide churn probabilities and indications of churn probabilities to the network churn generator client 102 or the user devices 106. The network churn manager 120D may provide churn probabilities and indications of churn probabilities based on operations of the clusterizor 120A, the feature manipulator 120B, and the model manager 120C. In some embodiments, the network churn manager 120D may target user devices having probabilities to churn (e.g., via feedback prompts, alerts, notifications, etc., related to additional or alternative services, deals, promotions, etc.). In some embodiments, the network churn manager 120D may trigger cell site operations based on one or more user devices having probabilities to churn.

### Example Flowchart

FIG. 2 includes flowchart 200, which begins at step 202 with retrieving particular network data and network experience data for a user device. In embodiments, the network experience data includes churn data. In some embodiments, the network data and the network experience data may comprise a dropped call rate, an access failure rate, historical network outages experienced, plan type, bundling data, feedback data, leakage, and a home address. In some embodiments, the network data is network data 134 and network experience data 136 of FIG. 1. In some embodiments, particular user data (e.g., user data 132), feedback data (e.g., feedback data 138), and share of household data (e.g., share of household data 140) may be retrieved for the user device.

In embodiments, the particular data retrieved may correspond to cell sites in which the user device communicates with over a threshold. In embodiments, the particular network data, network experience data, user data, feedback data, and share of household data may be retrieved for each cell site identified as communicating with the user device over the threshold. In some embodiments, the particular data retrieved, or the cell sites identified as communicating with the user device over the threshold, may correspond to historical location data of the user device. By way of example, historical locations may be identified that the user device frequented above a threshold.

Step 204 comprises retrieving particular network data and network experience data for particular other user devices. For example, other user devices that communicate with the cell sites, identified for the user device, over the threshold may be identified, and particular network data, network experience data, user data, feedback data, and share of household data may be retrieved for each of those other user devices. By way of example, the particular data may be retrieved for overlapping area portions between the user device and each of the other user devices for coverage areas of the identified cell sites. As another example, particular network data and network experience data for the other user devices may be retrieved. As another example, feedback data from the other user devices may also be retrieved, the feedback data associated with the network data and the network experience data for the identified cell sites. In some embodiments, the feedback data may be converted into a standardized format (e.g., via text normalization, tokenization, stop words removal, stemming and lemmatization, bag of words text transformation, Term Frequency-Inverse Document Frequency vectorising, word or document embeddings, etc.).

In some embodiments, previous churn events and call drops may be identified from the network experience data (e.g., for the user device or the other user devices). By way of illustration, the previous churn events and call drops may be identified based on associating a home address or work address with each of the user device and other user devices, geographical information (e.g., from a geographic information system (GIS), such as access point towers, antenna locations, antenna heights, antenna capabilities, routes and capabilities of cables and fiber optics, network equipment located on personal properties, topography and weather data, land use and vegetation, population density and subscriber locations, etc.) associated with locations that the user devices has frequented over the threshold, etc.

Step 206 comprises providing the network data and the network experience data to an adaptive machine learning model. By way of example, the particular network data, network experience data, user data, feedback data, and share of household data retrieved for the user device may be provided to the adaptive machine learning model for generating churn predictions, and the adaptive machine learning model may be generated and trained based on the particular network data, network experience data, user data, feedback data, and share of household data retrieved for the other user devices. In embodiments, the adaptive machine learning model is generated and trained based on utilizing the clusterizor 120A, feature manipulator 120B, and model manager 120C of FIG. 1.

In embodiments, the trained adaptive machine learning model, or a set of trained adaptive machine learning models, may be implemented directly into a radio head and node of at least one of the cell sites identified for the user device. For example, the set of trained adaptive machine learning models may comprise a supervised machine learning model and an unsupervised machine learning model (e.g., machine learning models 142 of FIG. 1). As another example, the trained adaptive machine learning model may be trained on dropped call rates, access failure rates, historical network outages experienced, plan types, bundling data, feedback data, leakage, and home addresses for each of a plurality of other user devices having a historical location frequented above a threshold, the historical location being a historical location that the user device frequented above the threshold.

In some embodiments, the trained adaptive machine learning model may be trained (e.g., by the model manager 120C of FIG. 1) based on generating a correlation matrix for the other user devices (e.g., associated with correlations among dropped call rates, feedback data, and home addresses for the other user devices) based on applying an increased weighted value to negative feedback from the feedback data for the other user devices. For example, in embodiments, the correlation matrix may be generated using the feedback data in the standardized format, the previous churn events, and the call drops. Additionally, the trained adaptive machine learning model may be trained based on applying an increased weighted value to higher dropped call rates, higher access failure rates, and higher historical network outages experienced (e.g., for a correlation matrix having correlations among dropped call rates, access failure rates, historical network outages experienced, feedback data, and home addresses for the other user devices).

In some embodiments, after applying the correlation matrix to generate the trained adaptive machine learning model, the trained adaptive machine learning model may be retrained by applying a confusion matrix (e.g., a square matrix of size n×n, wherein “n” is the number of classes associated with the particular network data, network experience data, user data, feedback data, and share of household data, wherein each row of the confusion matrix represents the instances in a predicted churn for the other user device inputs and each column represents the instances in an actual churn for the other user device). Based on retraining the adaptive machine learning model using the confusion matrix, the particular network data, network experience data, user data, feedback data, and share of household data for the user device may be provided to the trained adaptive machine learning model, such that the indication of churn is provided at step 208 based on utilizing the adaptive machine learning model. In some embodiments, based on retraining the adaptive machine learning model using the confusion matrix, unsupervised models of the adaptive machine learning model may be implemented for determining whether or not a user device has a probability to churn based on applying the input corresponding to that user device to the unsupervised adaptive machine learning model.

In embodiments, based on providing the particular network data, network experience data, user data, feedback data, and share of household data to the trained adaptive machine learning model, it may be determined that the user device has a particular churn probability (e.g., a probability to churn, a probability not to churn). In some embodiments, churn probabilities may be determined for other user devices based on providing particular network data, network experience data, user data, feedback data, and share of household data of the other user devices to the trained adaptive machine learning model, such that a second indication of the one of the other user devices having a particular churn probability provided at step 208.

In some embodiments, the trained adaptive machine learning model being trained by assigning each of the other user devices, that have one or more of network data, network experience data, user data, feedback data, and share of household data indicating a pattern of weak network coverage, an increased ranking identifier. For example, a pattern of weak network coverage may include a call drop rate above a threshold, RSSI below a threshold, data throughput below a threshold, blocked call rate above a threshold, handover failure rate above a threshold, signal to noise ratio below a threshold, packet loss rate above a threshold, negative feedback above a threshold, RSRP below a threshold, RSRQ below a threshold, SINR below a threshold, CQI below a threshold, timing advance above a threshold, etc., or one or more combinations thereof. Additionally or alternatively, the training may also comprise assigning each of the other user devices having linked accounts (e.g., based on user data 132 of FIG. 1, such as subscription bundles, or based on share of household data 140 of FIG. 1) an increased ranking identifier. In yet another example, a third set of the other user devices having historical data usage that is above a data usage threshold may also be assigned an increased ranking identifier. As such, a correlation matrix may be generated using ranking identifiers (e.g., including the increased ranking identifiers) for each of the user devices, applying the correlation matrix to generate the trained adaptive machine learning model.

In some embodiments, it may be determined that the user device has a particular churn probability using output from a dimensionality reduction algorithm (e.g., principal component analysis, linear discriminant analysis, t-distributed stochastic neighbor embedding, uniform manifold approximation and projection, independent component analysis, autoencoders, factor analysis, non-negative matrix factorization) that was applied to output from the trained adaptive machine learning model. For example, the output from the trained adaptive machine learning model may include a binary output binary output indicating that the user device will churn or not churn. In embodiments, the trained adaptive machine learning model is implemented directly into the radio head and eNodeB of a cell site, such that the trained adaptive machine learning model does not run outside of the cell site.

### Example Network Churn Generator Client

Referring now to FIG. 3, a diagram is depicted of an example network churn generator client suitable for use in implementations of the present disclosure. In particular, the example network churn generator client is shown and designated generally as network churn generator client 300. Example network churn generator client 300 is but one example of a suitable computing environment and is not intended to suggest any limitation as to the scope of use or functionality of the invention. Neither should network churn generator client 300 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 3, network churn generator client 300 includes bus 302 that directly or indirectly couples the following devices: memory 304, one or more processors 306, one or more presentation components 308, network churn generator interface 310, database interface 312, and power supply 314. The memory 304 may include network churn generator associated operating instructions 304A, which may be executed by the processor(s) 306 to perform network churn generator associated operations 306A. The one or more presentation components 308 may include network churn generator interface display 308A.

Although the components of FIG. 3 are shown with lines for the sake of clarity, in reality, delineating various components is not so clear, and metaphorically, the lines would more accurately be grey and fuzzy. For example, processors, such as one or more processors 306, have memory. The present disclosure hereof recognizes that such is the nature of the art, and reiterates that FIG. 3 is merely illustrative of an example network churn generator client 300 that may be used in connection with one or more implementations of the present disclosure.

In some embodiments, the network churn generator client 300 may be a “workstation,” “server,” “laptop,” “handheld device,” “computing device,” etc. In some embodiments, the network churn generator client 300 may be network churn generator client 102 of FIG. 1.

In some embodiments, bus 302 may represent what may be one or more busses (such as an address bus, data bus, or a combination thereof).

The network churn generator client 300 may include a variety of computer-readable media. Computer-readable media may be any available media that may be accessed by network churn generator client 300 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 304 includes computer-storage media in the form of volatile and/or nonvolatile memory. Memory 304 may be removable, non-removable, or a combination thereof. Examples of memory 304 may include solid-state memory, hard drives, optical-disc drives, etc., or one or more combinations thereof.

Example network churn generator client 300 also includes one or more processors 306 that read data from one or more entities, such as bus 302, memory 304, one or more presentation components 308, network churn generator interface 310, database interface 312, or power supply 314. In embodiments, the network churn generator interface 310 may be network churn generator interface 104 of FIG. 1. In embodiments, the network churn generator client 300 may communicate with network churn generator 120 of FIG. 1 via the network churn generator interface 310. In embodiments, the network churn generator client 300 may communicate with database 130 of FIG. 1 via the database interface 312.

Examples of one or more processors 306 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors, or one or more combinations thereof.

The processor(s) 306 may perform network churn generator associated operations 306A. For example, the network churn generator associated operations 306A may include causing the network churn generator 120 of FIG. 1 to receive, retrieve, extract, or identify particular network data and network experience data for particular user devices, causing adaptive machine learning models to be trained, causing the determinations user devices having a particular churn probability (e.g., a probability to churn that is above a threshold), receiving indications that a user device has a particular probability to churn, causing messages or notifications to be transmitted based on the user device having a particular probability to churn, etc., or one or more combinations thereof. In embodiments, the network churn generator associated operations 306A may include causing one or more of the steps (or portions thereof) discussed above with respect to FIG. 2.

One or more presentation components 308 may present (e.g., to a person or other device) various data instances (e.g., based on operations of the network churn generator 120 of FIG. 1). Examples of the one or more presentation components 308 may include a display device, speaker, printing component, vibrating component, etc. In some embodiments, the one or more presentation components 308 may present data received via the network churn generator interface 310 or the database interface 312.

In some embodiments, the network churn generator interface display 308A may display user data 132 of FIG. 1, network data 134, network experience data 136, feedback data 138, share of household data 140, training parameters for machine learning models 142, predicted churn probabilities, clusters generated by clusterizor 120A, features manipulated by feature manipulator 120B, management operations by the model manager 120C, operations performed by the network churn manager 120D, outputs provided by the machine learning models 142, historical selections associated with the machine learning models 142, other types of network churn generator output, etc., or one or more combinations thereof.

In embodiments, the network churn generator client 300 facilitates communication with a wireless telecommunications network (e.g., via a radio). Illustrative wireless telecommunications technologies may include CDMA, GPRS, TDMA, GSM, and the like. The network churn generator client 300 might additionally or alternatively facilitate other types of wireless communications including Wi-Fi, WiMAX, LTE, or other VoIP communications. As can be appreciated, in various embodiments, the network churn generator client 300 may be configured to support multiple technologies and/or multiple radios may be utilized to support multiple technologies.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system comprising:
one or more processors; and
computer memory storing computer-usable instructions that, when executed by the one or more processors, cause the one or more processors to perform operations comprising:
identifying cell sites with which a user device communicates over a threshold amount;
retrieving network data and network experience data for the cell sites;
providing the network data and the network experience data to a trained adaptive machine learning model;
based on providing the network data and the network experience data to the trained adaptive machine learning model, determining that the user device has a particular churn probability; and
providing an indication of the particular churn probability.

2. The system according to claim 1, further comprising:
identifying other user devices that communicate with the cell sites over the threshold amount;
retrieving the network data and the network experience data for the other user devices;
providing the network data and the network experience data for the other user devices to the trained adaptive machine learning model;
based on providing the network data and the network experience data to the trained adaptive machine learning model, determining that one of the other user devices has the particular churn probability; and
providing a second indication of the one of the other user devices having the particular churn probability.

3. The system according to claim 1, the trained adaptive machine learning model being implemented directly into a radio head and node of at least one of the cell sites.

4. The system according to claim 3, the trained adaptive machine learning model being trained by:
identifying other user devices that communicate with the cell sites over the threshold amount;
retrieving feedback data from the other user devices, the feedback data associated with the network data and the network experience data for the cell sites;
converting the feedback data into a standardized format;
identifying previous churn events and call drops from the network experience data for the other user devices;
generating a correlation matrix using the feedback data in the standardized format, the previous churn events, and the call drops; and
applying the correlation matrix to generate the trained adaptive machine learning model.

5. The system according to claim 4, further comprising: after applying the correlation matrix, retraining the trained adaptive machine learning model by applying a confusion matrix, and providing the network data and the network experience data to the trained adaptive machine learning model after applying the confusion matrix.

6. The system according to claim 3, the trained adaptive machine learning model being trained by:
identifying other user devices that communicate with the cell sites over the threshold amount;
assigning each of the other user devices, having the network data and the network experience data corresponding to the other user devices and indicating a pattern of weak network coverage, an increased ranking identifier;
assigning each of the other user devices having linked accounts an increased ranking identifier;
generating a correlation matrix using ranking identifiers for each of the other user devices; and
applying the correlation matrix to generate the trained adaptive machine learning model.

7. The system according to claim 1, further comprising:
based on providing the network data and the network experience data to the trained adaptive machine learning model, applying a dimensionality reduction algorithm to output from the trained adaptive machine learning model; and
determining that the user device has the particular churn probability using the output from the dimensionality reduction algorithm.

8. A method for network churn predictions, the method comprising:
identifying a cell site in which a user device communicates with over a threshold amount;
retrieving network data and network experience data for the cell site that corresponds to the user device;
providing the network data and the network experience data to a set of trained adaptive machine learning models;
based on providing the network data and the network experience data to the set of trained adaptive machine learning models, determining that the user device has a probability to churn; and
providing an indication of the user device having the probability to churn.

9. The method according to claim 8, the set of trained adaptive machine learning models being implemented directly into a radio head and node of the cell site.

10. The method according to claim 9, the set of trained adaptive machine learning models being trained by:
identifying other user devices that communicate with the cell site over the threshold amount and that have historical location data within a threshold distance from the user device;
retrieving the network data and the network experience data, for the other user devices, that corresponds to the cell site and the historical location data within the threshold distance;
retrieving feedback data from the other user devices, the feedback data corresponding to the cell site and the historical location data within the threshold distance;
identifying previous churn events and call drops from the network experience data retrieved for the other user devices;
generating a correlation matrix using the feedback data, the previous churn events, and the call drops; and
applying the correlation matrix to generate the set of trained adaptive machine learning models.

11. The method according to claim 10, the set of trained adaptive machine learning models comprising a supervised machine learning model and an unsupervised machine learning model.

12. The method according to claim 10, the set of trained adaptive machine learning models being trained by:
identifying a set of the other user devices having the network data and the network experience data that indicate a pattern of weak network coverage;
assigning the set of the other user devices an increased ranking identifier; and
generating the correlation matrix using ranking identifiers for each of the other user devices, the ranking identifiers including the increased ranking identifiers.

13. The method according to claim 12, the set of trained adaptive machine learning models being trained by:
identifying a second set of the other user devices having linked accounts; and
assigning the second set of the other user devices an increased ranking identifier.

14. The method according to claim 13, the set of trained adaptive machine learning models being trained by:
identifying a third set of the other user devices having historical data usage that is above a data usage threshold; and
assigning the third set of the other user devices an increased ranking identifier.

15. One or more computer storage media having computer-executable instructions embodied thereon, that when executed by at least one processor, cause the at least one processor to perform a method comprising:
identifying historical locations a user device frequented above a threshold amount;
retrieving network data and network experience data for the user device based on the historical locations;
providing the network data and the network experience data to a trained adaptive machine learning model;
based on providing the network data and the network experience data to the trained adaptive machine learning model, determining that the user device has a probability to churn; and
causing the transmission of an indication of the user device having the probability to churn.

16. The one or more computer storage media of claim 15, the network data and the network experience data comprising a dropped call rate, an access failure rate, historical network outages experienced, plan type, bundling data, feedback data, leakage, and a home address.

17. The one or more computer storage media of claim 16, the trained adaptive machine learning model being trained on dropped call rates, access failure rates, historical network outages experienced, plan types, bundling data, feedback data, leakage, and home addresses for each of a plurality of other user devices having at least one of the historical locations frequented above the threshold amount.

18. The one or more computer storage media of claim 17, the trained adaptive machine learning model being trained based on generating a correlation matrix for the plurality of other user devices based on applying an increased weighted value to negative feedback from the feedback data for the plurality of other user devices, and an increased weighted value to higher dropped call rates, higher access failure rates, and higher historical network outages experienced.

19. The one or more computer storage media of claim 18, further comprising:
after applying the correlation matrix to generate the trained adaptive machine learning model, retraining the trained adaptive machine learning model by applying a confusion matrix, and providing the network data and the network experience data to the trained adaptive machine learning model after applying the confusion matrix.

20. The one or more computer storage media of claim 19, the trained adaptive machine learning model being implemented directly into a radio head and node of a cell site associated with the historical locations.
